(19) United States
(12) Patent Application Publication
(10) Pub. No.: US 2006/0200389 A1
(43) Pub. Date: Sep. 7, 2006

(54) Photographic image outputting system

(75) Inventor: Yusuke Kitagawa, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/368,447

(22) Filed: Mar. 7, 2006

(30) Foreign Application Priority Data
Mar. 7, 2005 (JP) 062442/2005

(51) Int. Cl. G06Q 30/00

(52) U.S. Cl. 705/26

(57) ABSTRACT

A photographic image outputting system of the present invention is equipped with: an order receiving apparatus for receiving orders for photographic image output and a desired completion time; an output processing apparatus for performing output processes; and a control apparatus (e.g., a server) for controlling the output processing apparatus. The control apparatus judges whether completion by the desired completion time is possible, based on the contents of a new order and the processing states of existing orders, then sends the judgment results to the order receiving apparatus. The order receiving apparatus has notifying means for displaying the judgment results of the control apparatus to users. The control apparatus generates schedules for orders, which are deliverable by the desired completion time, and controls each process such that the order is processed according to the schedules.

### BACKGROUND OF THE INVENTION

1. Field of the Invention

The present invention relates to a photographic image outputting system.

2. Description of the Related Art

Photographic printing systems that comprise an order receiving apparatus, for receiving orders for photographic prints, and a print processing apparatus, for performing printing processes on the orders received by the order receiving apparatus, are known. The print processing apparatus performs processes related to the printing operation, and the printing operation itself. There are systems in which the related processes and the printing operation are performed by the same apparatus, and systems in which the related processes and the printing operations are performed by a printing related processing apparatus and a print executing apparatus (such as a printer), respectively.

In these photographic printing systems, the order receiving apparatus receives printing orders in units of: recording media, such as users' memory cards, image groups transmitted via a network or the like, or photographic films. The printing related processing apparatus performs processes related to printing with respect to each order received by the order receiving apparatus, and causes the print executing apparatus to execute printing operations. Generally, the order receiving apparatus is capable of receiving orders to print all of the photographic images recorded in a recording medium, all of the photographic images of an image group, and all of the photographic images recorded on photographic film. In addition, the order receiving apparatus is capable of receiving orders to print photographic images selected by a user from among the photographic images recorded in a recording medium, photographic images selected by a user form among the photographic images of an image group, and photographic images selected by a user from among the photographic images recorded on photographic film.

The processes related to printing performed by the printing related processing apparatus include: image quality correcting processes, for improving the image quality of images included in an order; and format converting processes, for converting the images to a format compatible with the print executing apparatus, for example. In addition, in the case that an order for printing is for photographic images, which are recorded on photographic film, the printing related processing apparatus performs processes to obtain image data sets, by reading out the photographic images with a scanner or the like. In a system in which a single printing related processing apparatus is connected to a plurality of print executing apparatuses via a network, the printing related processing apparatus may also perform processes to select an appropriate print executing apparatus, according to the processing states of each print executing apparatus. Note that the printing related processing apparatus generally performs the processes related to printing regarding orders, in the order that the orders are received by the order receiving apparatus.

The printing related processing apparatus outputs the photographic images of orders, for which the processes related to printing have been completed, to the print executing apparatus. The print executing apparatus executes printing of the photographic images of each order transmitted from the printing related processing apparatus to obtain photographic prints. Note that in the case that a new order is transmitted during execution of a printing operation, the print executing apparatus temporarily stores the photographic images of the new order into a built in memory device. Following completion of the printing operation, the photographic images stored in the memory device are printed in the order that they were received.

The system described above is not limited to printing photographic images, that is, outputting photographic images onto print papers. The system may be applied to record photographic images onto recording media, such as CD-R's and DVD's. In the description of the present invention hereinafter, the term “output” will refer collectively to outputting photographic images by printing onto paper and to outputting photographic images by recording onto recording media. Systems that perform output of photographic images by printing and by recording onto recording media will be referred to as “photographic image outputting systems”.

Various attempts have been made to facilitate use of such photographic image outputting systems, and to enable better service to be provided thereby. For example, Japanese Unexamined Patent Publication No. 2004-310746 discloses a scheduling mode, in which completion times of print jobs (that is, orders) are prioritized. In the scheduling mode, schedules are determined in which the completion time is prioritized over costs, that is, expedient processing is prioritized. The print jobs are processed according to the determined schedule, thereby enabling expedient output of the print jobs.

There are two basic types of orders for photographic image output, with regard to requirements regarding completion times. The first type of order is that which is desired to be output as soon as possible. The other type of order is that which is only desired to be output by a time convenient to the user. For example, if a user places an order at the order receiving apparatus, then runs errands for four hours, it is important to this user that the order is completed by the time that he returns to the apparatus. That is, it only matters to the user that the order is completed within four hours, and it is not necessary for the order to be completed prior to his return. The method disclosed in Japanese Unexamined Patent Publication No. 2004-310746 performs processes based on the schedules, which are determined to output print jobs as soon as possible, disregarding the wishes of users. Therefore, a case may arise, in which the order of the above user is completed and output 30 minutes after the user places the order. When this user returns four hours later, there is no problem for him, as his order had been completed by his return. However, if another user places an order immediately after the above user and wishes for her order to be output in 15 minutes, for example, a problem arises that the completion time will be after the previous user's order is processed (longer than 30 minutes after she places her order).

In addition, users cannot know whether output of their order by their desired completion time is possible. Therefore, users may hesitate when deciding whether to place an order.

### SUMMARY OF THE INVENTION

The present invention has been developed in view of the foregoing circumstances. It is an object of the present invention to provide a photographic image outputting system that provides a more convenient service, while taking desired completion times of orders into consideration.

The photographic image outputting system of the present invention comprises:

an order receiving apparatus having receiving means, for receiving orders for photographic image output;

an output processing apparatus, for performing output processes regarding the orders received by the order receiving apparatus; and

a control apparatus, for controlling the output processing apparatus; wherein:

the receiving means also receives a desired completion time;

the control apparatus comprises:

scheduling means, for judging whether completion by the desired completion time for a new order is possible, based on the contents of the new order received by the receiving means and the processing state of existing orders received prior to the new order, and for generating an output processing schedule for the new order, in the case that it is judged that completion by the desired completion time is possible; and

schedule control means, for causing the output processing apparatus to perform outputting processes for the new order according to the schedule generated by the scheduling means; and

the order receiving apparatus further comprises:
notifying means, for displaying the results of the judgment performed by the scheduling means.

Here, the outputting processes performed by the output processing apparatus may be a process in which the photographic images included in the order are printed, a process in which the photographic images are recorded in a recording medium, or both.

Examples of the recording medium are portable media, such as: CD-R's, DVD's, and memory cards.

The contents of the order for photographic image output refer to factors that relate to the output processing time required for the order. Examples of such factors are: the number of images to be output included in the order; the number of copies to be output; the input format of the images (photographic film, memory card, transmission via a network, etc.); print size; and the type of recording medium. The amount of time required for the output processes of an order varies depending on the contents thereof.

The “existing orders” include orders that are standing by for output processes to be administered thereon (hereinafter, referred to as “process standby orders”), in addition to those on which output processes are being administered by the output processing apparatus (hereinafter, referred to as “current process orders”). The photographic image outputting system of the present invention generates a schedule for each order, and controls the output processing apparatus to perform output processes on each order according to its schedule. Therefore, the “processing state of existing orders” refers to whether the orders are being processed or standing by, the schedule of a current process order, such as completion time of output processes therefor, the schedules of process standby orders, such as initiation time and completion time, and the like.

The scheduling means of the control apparatus in the photographic image outputting system of the present invention generates schedules for new orders such that the new orders are output by the desired completion time. The schedules may be generated such that output can be completed at any time prior to the desired completion time. For example, in the case that the desired completion time is four hours after the time of order placement, a schedule may be generated such that the output processes are completed at any time within four hours after the time of order placement, such as three hours after the time of order placement. However, it is preferable that the schedules are generated such that output is completed as soon as possible, within the allowable period of time.

The order receiving apparatus comprises the notifying means, for displaying the judgment results of the scheduling means (that is, whether completion of a new order by the desired completion time is possible). The notifying means may be of any configuration, as long as it is capable of notifying a user of the judgment results, in the case that the user himself places an order at the order receiving apparatus, and capable of notifying an operator of the judgment results, in the case that the operator places an order at the order receiving apparatus according to the user's wishes. Examples of the notifying means are: an audio notifying means; and a text display means.

A configuration may be adopted, wherein:

the scheduling means performs the judgment and generates the schedule after adjusting the schedules of existing orders, for which the schedules are adjustable within an adjustable range; and

the schedule control means controls the output processing apparatus such that existing orders, of which the schedules have been adjusted, are output according to the adjusted schedule thereof.

Here, the phrase “existing orders, for which the schedules are adjustable” refers to existing orders for which schedules have been generated such that the outputs thereof will be completed before the desired completion times. The term “adjustable range” refers to a range of time in which the adjustment would not delay completion of the existing order beyond the desired completion time. As described previously, the scheduling means generates schedules for new orders such that the outputs thereof are completed before the desired completion time, and not such that the outputs thereof coincide with the desired completion time. Therefore, there is a possibility that there are existing orders, of which the schedules may be adjusted such that the outputs thereof may be completed later than the schedules which have been generated therefor.

It is desirable that:

the control apparatus further comprises possible completion time calculating means, for calculating a possible completion time when the new order can be completed, in the case that the scheduling means judges that completion by the desired completion time is not possible; and

the notifying means displays the possible completion time calculated by the possible completion time calculating means.

Further, it is preferable that:

the control apparatus further comprises reference completion time calculating means, for calculating a reference completion time when a new order having standard contents (for example, outputting one print each of 36 images recorded in a memory card at a print size of 89 mm×127 mm without a border) can be completed at the time that the new order is received, based on the schedules of existing orders; and

the notifying means displays the reference completion time calculated by the reference completion time calculating means. In this case, it is desirable for the notifying means to display the standard contents employed to calculate the reference completion time along with the reference completion time.

The reference completion time may be displayed continuously (in this case, notifying means other than the audio notifying means is preferable, so as to not be bothersome to the user). Alternatively, the reference completion time may be displayed in the case that there is a possibility that a user may place an order, or when the user indicates a desire for the reference completion time to be displayed. The “possibility that a user may place an order” may be determined by providing a sensor on the order receiving apparatus, and detecting when a person approaches the order receiving apparatus. Alternatively, the “possibility that a user may place an order” may be determined to be when a user accesses the order receiving apparatus via a network, inserts a memory card into the order receiving apparatus, or inserts photographic film into the order receiving apparatus. In addition, the indication of “desire for the reference completion time to be displayed” may be accomplished by providing a “Display Reference Completion Time” button on the order receiving apparatus, and prompting the user to press the button.

The manner of displaying the possible completion time or the reference completion time may be either direct or indirect. That is, the completion times may be displayed as “will be completed at X o'clock” or “X hours and Y minutes until completion”.

It is preferable that a configuration be adopted, wherein:

the receiving means receives the orders for photographic image output with different degrees of output priorities;

the scheduling means generates the schedules such that output processes are performed first for orders having higher degrees of output priorities, and judges whether completion of a new order is possible, according to the degree of output priority of the new order and the degrees of output priorities of the existing orders.

Here, the “degrees of output priorities” represents relative priorities among orders. It is not necessary for numerical values, such as “priority 1” and “priority 2” to be assigned. Degrees of priority, such as “Priority” and “Standard” may be assigned to the orders. Note that here, “Standard” means that the order is not prioritized when compared against other orders. The “Standard” assignment therefore represents a degree of priority.

Because the degree of priority represents the relative degree by which the output processes of orders are prioritized, there are at least two assignable degrees of priority (“Priority” and “Standard”, for example).

Prioritized processing of higher priority orders by the output processing apparatus includes prioritized processing of some of the output processes performed by the output processing apparatus, as well as prioritized processing of all of the processes performed by the output processing apparatus.

For example, the output processing apparatus may comprise a printing related processing apparatus for performing processes related to outputting orders received by the order receiving apparatus, and an output executing apparatus for executing the output process for the order. In a similar manner, in the case that the output processing apparatus comprises a plurality of means for executing each of a plurality of steps, a single means from among the plurality of means may perform prioritized processing for higher priority orders, or some to all of the means may perform prioritized processing for higher priority orders.

Examples of the output executing apparatus are a printer that executes printing operations, and a recording apparatus, for recording data onto recording media.

In the photographic image outputting system of the present invention, the order receiving apparatus receives new orders and desired completion times for the new orders. The control apparatus judges whether completion of the new orders is possible by the desired completion times, based on the contents of the new orders and the processing state of existing orders. The order receiving apparatus notifies the judgment results obtained by the control apparatus. Thereby, a user or an operator of the order receiving apparatus can be informed whether it is possible for an order to be completed by a desired completion time. Accordingly, the user can decide whether to place the order, to change the desired completion time and then place the order, or to cancel the order.

The control apparatus generates schedules for received orders, and controls the output processing apparatus such that the output processes are performed according to the schedules. Thereby, judgment regarding whether completion of new orders by their desired completion times is possible is enabled.

In the photographic image outputting system of the present invention, a configuration may be adopted, wherein: the scheduling means performs the judgment and generates the schedule after adjusting the schedules of existing orders, for which the schedules are adjustable within an adjustable range. In this case, the maximum number of new orders can be received, while all orders are output by their desired completion times, which is efficient.

In the photographic image outputting system of the present invention, a configuration may be adopted, wherein: a possible completion time when a new order can be completed is calculated and displayed, in the case that the scheduling means judges that completion by the desired completion time is not possible. In this case, it is easy for a user to decide whether to change the desired completion time and place the new order or to cancel the new order.

Further, a configuration may be adopted, wherein the photographic image outputting system of the present invention calculates and displays a possible completion time for a new order having standard contents at the time the new order is to be placed. In this case, a user can know the approximate possible completion time for their order prior to placing their order, which is convenient.

In the photographic image outputting system of the present invention, a configuration may be adopted, wherein: orders for photographic image output are received having different degrees of priority; and judgments regarding whether the orders can be completed by the desired completion time and generation of a schedules therefor are performed based on the degrees of priority of the orders. In this case, it becomes possible to provide a more detailed service, wherein: although it would be impossible to complete output by the desired completion time for an order having “degree of priority 1”, it would be possible to complete output by the desired completion time for an order having “degree of priority 2”, which is a higher degree of priority. The provider of the system services may charge a higher rate for higher priority orders, thereby satisfying users' needs for output of orders by their desired completion times, and increasing profits.

### BRIEF DESCRIPTION OF THE DRAWINGS

FIG. 1 is a block diagram that illustrates the construction of a photographic printing system, which is an embodiment of the photographic image output system of the present invention.

FIG. 2 is a block diagram that illustrates the construction of a server of the photographic printing system of FIG. 1.

FIG. 3 is a block diagram that illustrates the construction of a printing related processing section of the server of FIG. 2.

FIG. 4 is a block diagram that illustrates the construction of a processing sequence control means of the printing related processing section of FIG. 3.

FIG. 5 is a flow chart that illustrates the processes performed by the printing related processing section of FIG. 3.

FIG. 6 is a block diagram that illustrates the construction of a control section of the server of FIG. 2.

FIG. 7 is a schematic view that illustrates the contents of a database within the control section of FIG. 6.

FIG. 8 is a first flow chart that illustrates the processes performed by an output means of the control section of FIG. 6.

FIG. 9 is a second flow chart that illustrates the processes performed by an output means of the control section of FIG. 6.

FIGS. 10A, 10B, and 10C are diagrams for explaining the operations of a scheduling means of the control section 80 of the control section 80 of FIG. 6.

FIG. 11 is a block diagram that illustrates the construction of an order receiving apparatus of the photographic printing system of FIG. 1.

FIG. 12 is an example of a display screen of a display section of the order receiving apparatus of FIG. 11.

FIG. 13 is a flow chart that illustrates the operation of the order receiving apparatus of FIG. 11.

FIG. 14 is a flow chart that illustrates the processes related to order reception of the server of FIG. 2.

### DESCRIPTION OF THE PREFERRED EMBODIMENTS

Hereinafter, a preferred embodiment of the present invention will be described with reference to the attached drawings.

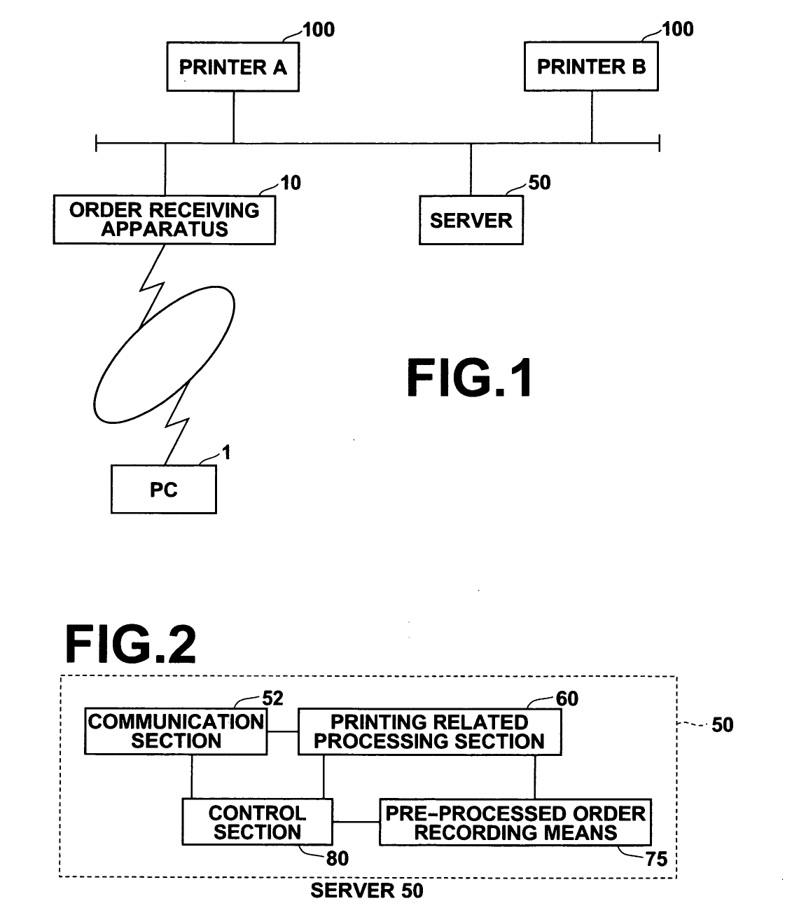

FIG. 1 is a block diagram that illustrates the construction of a photographic printing system, which is an embodiment of the photographic image output system of the present invention. As illustrated in FIG. 1, the photographic printing system of the present embodiment comprises: an order receiving apparatus 10, for receiving orders for photographic prints; a server 50; and a plurality of printers 100 (in the present embodiment, a printer A and a printer B are illustrated as examples). The order receiving apparatus 10, the server 50, and the printers 100 are connected via a network. In addition, the order receiving apparatus 10 is capable of connecting with user terminals PC1, via the Internet.

The order receiving apparatus 10 receives orders. The server 50 administers printing related processes on the orders received by the order receiving apparatus 10, and transmits the orders to the printers 100. The printers 100 execute printing of the orders transmitted thereto from the server 50, to obtain photographic prints. The processes from order placement to completion of printing are performed by the order receiving apparatus 10, the server 50, and the printers 100, in this order. However, the processes will be described in the order of the printers 100, the server 50, and the order receiving apparatus 10, to simplify the descriptions thereof.

The printers 100 obtain photographic prints, by executing printing operations for each image included in the orders transmitted thereto from the server 50. When the printing operation is completed for an order, notification of printing completion, here, an order number for the order, is transmitted to the server 50, to notify completion of the printing operation. Note that if the server 50 transmits a next order to the printers 100 in response to the notification of printing completion, the printers execute printing operations for the next order. However, if the server 50 does not transmit a next order, the printers 100 stand by until a next order is received.

FIG. 2 is a block diagram that illustrates the construction of the server 50 of the photographic printing system of FIG. 1. As illustrated in FIG. 2, the server 50 comprises: a communication section 52; a printing related processing section 60; a pre-processed order recording means 75, for recording orders, on which printing related processes have been administered by the printing related processing section 60 and which are not output to the printers 100, therein; and a control section 80, for controlling the communication section 52, the printing related processing section 60, and the pre-processed order recording means 75. The communication section 52 transmits and receives orders to and from the order receiving apparatus 10 and the printers 100. Images, which are included in orders received by the order receiving apparatus 10, are input to the server 50 via the communication section 52. The printing related processing section 60 administers processes related to printing on the images input thereto via the communication section 52. These processes can be roughly divided into: automatic setup processes, which are performed automatically; and verification processes, which are performed by an operator. Specific examples of the automatic setup processes, which are performed automatically, include: correction processes for improving image quality (such as exposure correction, sharpness correction, and white balance correction); and processes based on the contents of orders (such as enlargement/reduction according to print size, sepia tone finish, and fitting images into templates for special orders). Specific examples of the verification processes include: confirmation of the results of the automatic setup processes; correction in the case that the results of the automatic setup processes are unsatisfactory; and other processes, which are unable to be performed during the automatic setup processes. Examples of operator executed correction processes are: adjusting density to be higher, in the case that an exposure corrected image is too light; and adjusting density to be lower, in the case that a face pictured within an image is too dark. The verification processes correct deficiencies that result from the automatic setup processes. An example of a process which is unable to be performed during the automatic setup processes is setting the number of prints to be output for an image, in which a plurality of people are pictured, to the number of people pictured in the image.

The pre-processed orders, which are obtained by the printing related processing apparatus 60 administering the printing related processes thereon, are output to the printers 100 via the communication section 52. However, the pre-processed orders are stored in the pre-processed order recording means 75 until they are output. Note that output of the pre-processed orders from the pre-processed order recording means 75 is controlled by the control section 80.

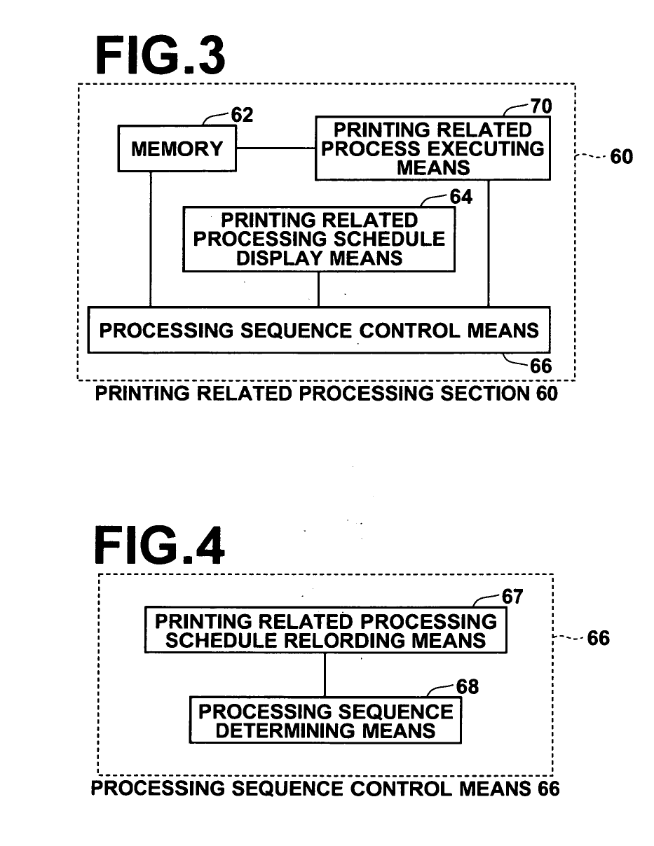

Here, the printing related processing section 60 will be described. As illustrated in FIG. 3, the printing related processing section 60 of the server 50 comprises: a memory 62; a related processing schedule display means 64; a processing sequence control means 66; and a printing related process executing means 70. The memory 62 stores orders prior to being processed by the printing related process executing means 70 therein. The printing related process executing means 70 performs the aforementioned automatic setup processes as well as the verification processes. The processing sequence control means 66 controls the sequence in which the orders recorded in the memory 62 are output to the printing related process executing means 70.

When the control section 80 causes the printing related processing section 60 to perform the printing related processes for a new order, the control section 80 issues schedules for the printing related processes (hereinafter, referred to as “related processing schedules”) for the new order as well as the orders recorded in the memory 62, awaiting the printing related processes to be administered thereon. Further details regarding the operations of the control section 80 will be described later. In the photographic printing system of the present embodiment, the related processing schedules issued by the control section 80 comprise “related processing initiation time”, and “related processing completion time”. The processing sequence control means 66 causes the printing related process executing means 70 to execute the printing related processes on orders, in a sequence according to the related processing schedules issued for each order. At the same time, the processing sequence control means 66 displays the related processing schedules on the related processing schedule display means 64, which is a monitor or the like. FIG. 4 is a block diagram that illustrates the construction of the processing sequence control means 66 of the printing related processing section 60. As illustrated in FIG. 4, the processing sequence control means 66 comprises: a related processing schedule recording means 67; and a sequence determining means 68.

As described previously, the memory 62 of the printing related processing section 60 stores orders prior to being processed by the printing related process executing means 70 therein. The related processing schedule recording means 67 of the processing sequence control means 66 records the related processing schedules for each order recorded in the memory 62, correlated with the order number thereof.

The sequence determining means 68 determines the sequence of orders to be output from the memory 62, based on the related processing schedules recorded in the related processing schedule recording means 67. The output sequence is determined such that orders having the most imminent related process initiation times in their printing schedules are output first.

Meanwhile, the processing sequence control means 66 renews the related processing schedules recorded in the related process schedule recording means 67, when new related processing schedules are issued by the control section 80. At the same time, the processing sequence control means 66 displays the new related processing schedules on the related processing schedule display means 64. Simultaneously, the sequence determining means 68 determines the output sequence of orders from the memory 62 according to the newly issued related processing schedules.

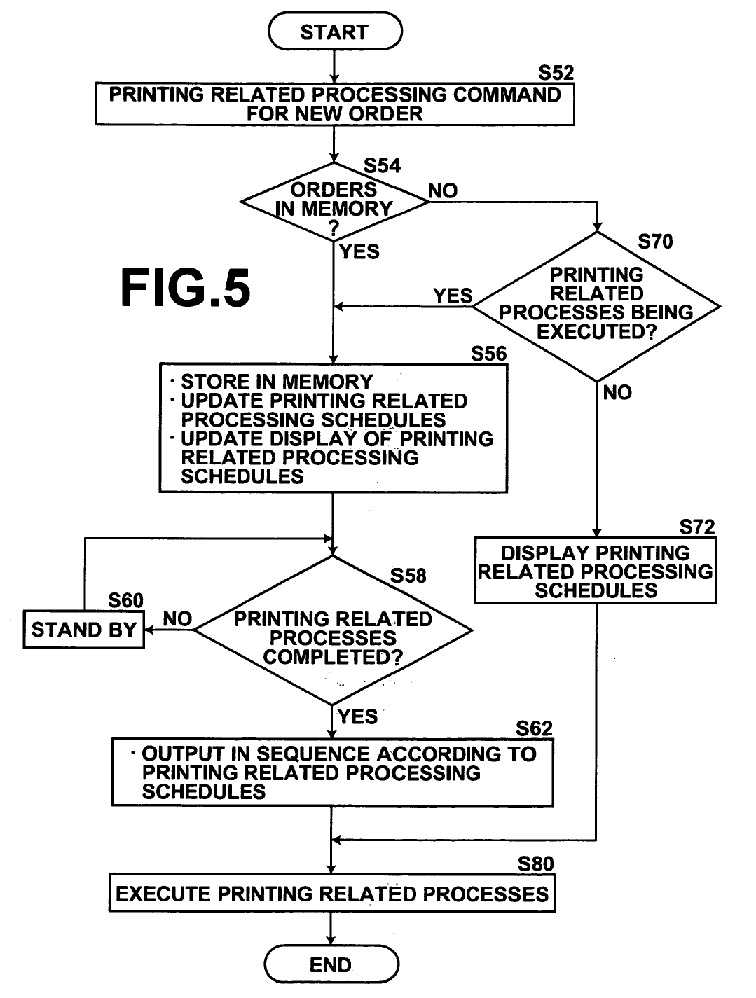

FIG. 5 is a flow chart that illustrates the processes performed by the printing related processing section 60 of FIG. 3. As illustrated in FIG. 5, when a printing related processing command is issued from the control section 80 (and a new related processing schedule is issued), the processing sequence control means 66 of the printing related processing section 60 first determines whether there are any orders awaiting processing in the memory 62 (steps S52, S54). In the case that there are orders awaiting processing in the memory 62 (which indicates that the related process executing means 70 is processing a different order at this time), the processing sequence control means 66 records the new order in the memory 62. At the same time, the processing sequence control means 66 renews the related processing schedules recorded in the related process schedule recording means 67, and causes the new related processing schedules to be displayed by the related processing schedule display means 64 (step S54: YES, step S56).

The processing sequence control means 66 monitors whether the printing related process executing means 70 has completed processing the other order (step S58), while orders are recorded in the memory 62 by step S56. The processing sequence control means 66 stands by until the processing is completed (step S58: NO, step S60). When the processing by the printing related process executing means 70 completes processing of the other order (step S58: YES), the processing sequence control means 66 outputs an order to the printing related process executing means 70 from the memory 62. Here, the sequence, in which the orders recorded in the memory 62 are output to the printing related process executing means 70, is determined based on the related processing schedules which are recorded in the related processing schedule recording means 67. The order having the most imminent related processing initiation time from among the orders recorded in the memory 62 is output first, then the order having the next imminent related processing initiation time is output, and so on. In this manner, the orders awaiting processing are output from the memory 62 to the printing related process executing means 70.

The printing related process executing means 70 administers the printing related processes on the order output thereto from the memory 62, to obtain a pre-processed order (step S80). Note that although not shown, the printing related process executing means 70 transmits the order number of each order, for which the printing related processes have been completed, to the control section 80, to notify the control section 80 of completion of the printing related processes therefor.

The processing sequence control means 66 of the printing related processing section 60 deletes the schedules of orders, for which the printing related processes have been completed by the printing related process executing means 70, from the contents to be displayed by the related processing schedule display means 64, and also deletes the schedules from the related processing schedule recording means 67.

On the other hand, in the case it is judged in step S54 that there are no orders awaiting processing recorded in the memory 62, the processing sequence control means 66 confirms whether the related process executing means 70 is processing another order (step S54: NO, step S70). If the printing related process executing means 70 is processing another order (step S70: YES), the processing sequence control means 66 outputs the new order to the memory 62, and the processes from step S56 onward are performed. If it is judged in step S70 that the printing related process executing means 70 is in standby mode, that is, not processing any other orders (step S70: NO), the processing sequence control means 66 outputs the new order to the printing related process executing means 70 directly, and causes the related processing schedule display means 64 to display the related processing schedule for the new order (step S72). The printing related process executing means 70 performs the printing related processes for the new order, to obtain a pre-processed order (step S80).

As described previously, the printing related processes performed by the printing related process executing means 70 comprise: the automatic setup processes, which are performed automatically; and the verification processes, which are performed by an operator. Therefore, although not shown in FIG. 3, the printing related process executing means 70 comprises: an automatic setup section, for performing the automatic setup processes; and an operating section, for an operator to perform the verification processes. The automatic setup section performs automatic setup on orders which have been output thereto from the processing sequence control means 66 or from the memory 62. The operator performs the verification processes on orders, for which the automatic setup processes have been completed. At this time, the related processing schedules of each order are displayed by the related processing schedule display means 64. Therefore, the operator can complete the verification processes of the orders by the related processing completion times indicated in the related processing schedules therefor.

Next, the control section 80 of the server 50 will be described. In the photographic print system of the present embodiment, the control section 80 is configured to serve the following functions.

Function 1: To calculate a completion time by which a new order having standard contents which is to be received at the present time can be completed, based on the processing state of the printing related processing section 60 and the printers 100, and to output this completion time as a reference completion time to the order receiving apparatus.

Note that “standard contents” of an order in the photographic print system of the present embodiment are “generating one print of 36 images, with print sizes of 89 mm×127 mm, without borders”, as an example.

Function 2: To judge whether output of a new order received by the order receiving apparatus 10 is possible by a desired completion time.

Function 3: To calculate a possible completion time for a new order, for which output by the desired completion time has been judged to be impossible by Function 2, and to output the possible completion time to the order receiving apparatus 10.

Function 4: To generate a printing related processing schedule and a printing schedule for a new order, for which output by the desired completion time has been judged to be possible by Function 2.

Function 5: To control each component of the system such that processes are performed according to the schedule generated in Function 4.

The order receiving apparatus 10 of the photographic print system according to the present embodiment is capable of receiving orders as “priority” orders and as “standard” orders. Further details of the order receiving apparatus 10 will be described later. The control section performs the calculation of the reference completion time, the calculation of the possible completion time, and the like separately for the priority orders and the standard orders.

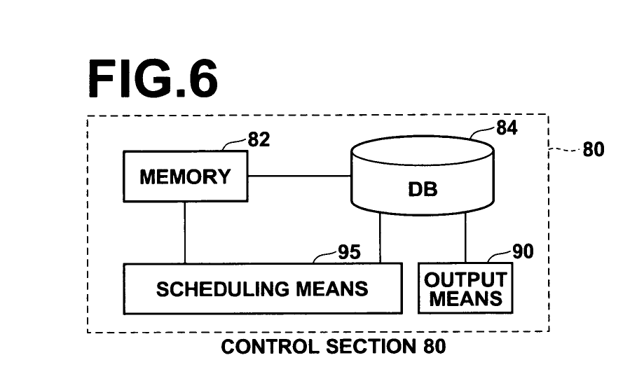

FIG. 6 is a block diagram that illustrates the construction of the control section 80 of the server 50. As illustrated in FIG. 6, the control section 80 comprises: a memory 82; a database 84; a scheduling means 95, for performing the aforementioned Functions 1, 2, 3, and 4; and an output means 90, for performing the aforementioned Function 5. First, the database 84 will be described.

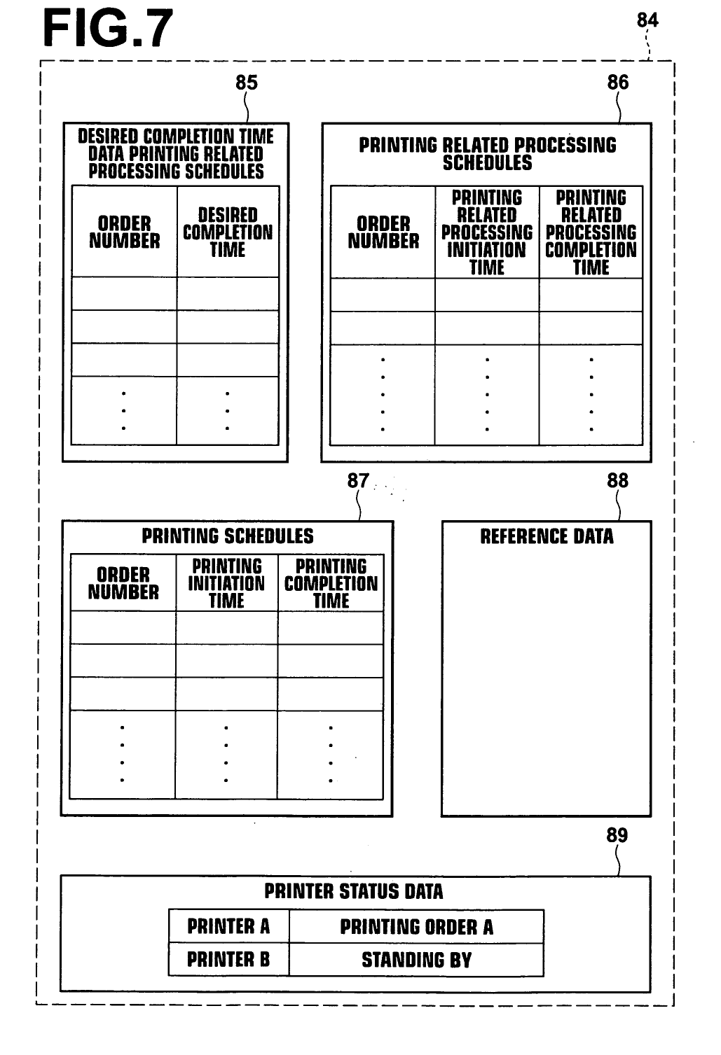

FIG. 7 is a schematic view that illustrates the contents of the database 84. As illustrated in FIG. 7, the database 84 has recorded therein: desired completion time data 85, comprising the desired completion times for existing orders (orders that have been received, but for which printing has not been completed) within the system, for each order number; printing related processing schedules 86 of the orders, for which the printing related processes have not been completed, from among the existing orders; printing schedules 87 for all of the existing orders; reference data 88, for calculating the printing related processing schedules and the printing schedules; and printer status data 89 that represents the operating state of each of the printers 100. The printing related processing schedules 86 and the printing schedules 87 stored in the database 84 are calculated by the scheduling means 95. Further details of the scheduling means 95 will be described later.

Here, the reference data 88 is data that represents the processing capabilities of the printing related processing section 60 (for example, the amount of time required for the printing related processing means 70 of the printing related processing section 60 to perform the automatic setup operations for a single image, and the amount of time required for the printers 100 to print a single print, according to the size of the print). The printing related processing schedules 86 comprise the related processing initiation times and related processing completion times of an order which is being processed by the printing related process executing means 70 and the orders recorded in the memory 62, which have not undergone the printing related processes. The printing schedules 87 comprises the printing initiation times and the printing completion times for all of the existing orders (that is, the orders, on which printing related processes have not been administered, recorded in the memory 62 of the printing related processing section 60; the order being processed by the printing related process executing means 70; and pre-processed orders, which are recorded in the pre-processed order recording means 75). Note that in the present embodiment, the time when an order is transmitted to one of the printers 100 is designated as the printing initiation time.

The output means 90 functions to control the components of the system such that the processes for each order are performed according to the schedules generated in Function 5 above, that is, generated by the scheduling means 95. The output means 90 outputs new orders, of which order placement has been confirmed (confirmation of order placement will be described later), to the printing related processing section 60, and outputs pre-processed orders, obtained by the printing related process executing means 70, to the printers 100.

The output means 90 of the control section 80 outputs the printing related processing schedule 86 that corresponds to a new order to the printing related processing section 60 along with the new order, when outputting the new order to the printing related processing section 60. The printing related processing schedule 86 for the new order is deleted from the database 84, when the order number thereof is received from the printing related process executing means 70 upon completion of the printing related processes therefor.

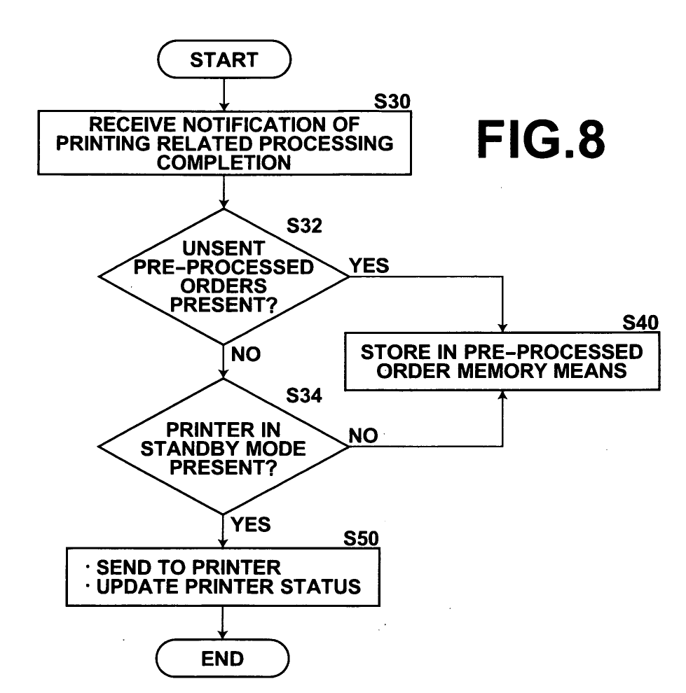

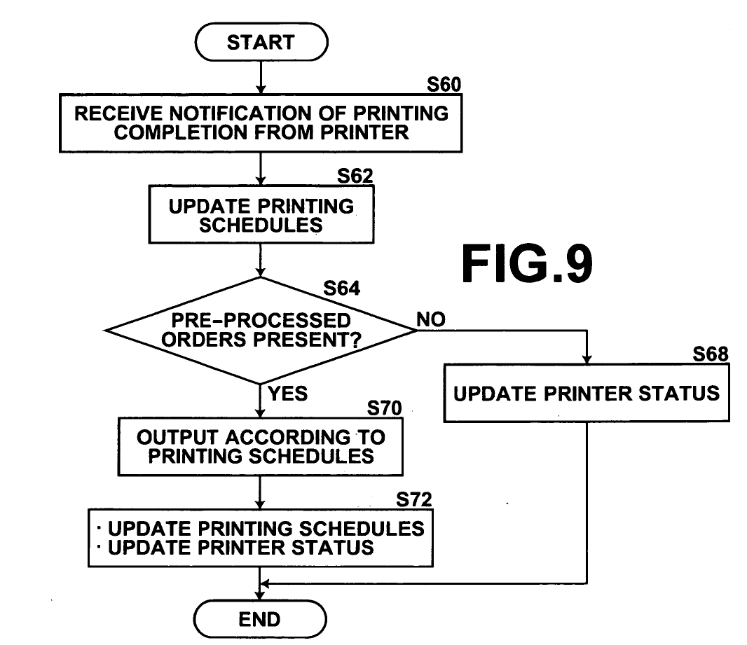

The output means 90 of the control section 80 outputs the pre-processed orders, obtained by the printing related process executing means 70 f the printing related processing section 60, to the printers 100 and causes the printers 100 to perform printing operations. Here, the process by which the output means 90 outputs the pre-processed orders to the printers 100 will be described in detail, with reference to the flow charts of FIGS. 8 and 9.

FIG. 8 is a flow chart that illustrates the operation of the output means 90, when the output means 90 receives notification from the printing related process executing means 70 that printing related processes have been completed for an order. As illustrated in FIG. 8, the output means 90 receives notification from the printing related process executing means 70 that the printing related processes have been completed for an order (designated as “order A”)(step S30). Upon receipt of this notification, first, the output means 90 confirms whether there are any pre-processed orders recorded in the pre-processed order recording means 75 awaiting transmission to the printers 100 (step S32). In the case that there are pre-processed orders recorded in the pre-processed order recording means 75 (step S32: YES), the output means 90 records order A in to pre-processed order recording means 75 and stands by (step S40). On the other hand, if there are no pre-processed orders recorded in the pre-processed order recording means 75 (step S32: NO), the output means 90 refers to the printer status data 89 in the database 84, to confirm whether there is a printer 100 in the standby state (step S34). In the case that there is a printer 100 in the standby state (step S34: YES), the output means 90 directly transmits the order A to the printer 100, updates the printer status data 89 for the printer 100 to “printing order A” in the database 84 (step S50). On the other hand, in the case that there are no printers 100 in the standby state (step S34: NO), the output means 90 records the order A into the pre-processed order recording means 75 (step S40), and stands by.

FIG. 9 is a flow chart that illustrates the operation of the output means 90, when it receives notification of printing completion from either of the two printers 100. As described previously, the printers 100 notifies the server 50 of printing completion for orders, by transmitting the order numbers for orders which have been printed. As illustrated in the flow chart of FIG. 9, when the output means 90 receives notification of printing completion from either of the printers 100 (step S60), the output means 90 updates the printing schedules 87 (step S62). The printing schedules 87 include the printing schedules for all orders for which printing has not been completed, regardless of whether the orders have been transmitted to the printers 100. Therefore, the output means 90 deletes the printing schedule of the order, regarding which the printing completion notification has been received, from the printing schedules 87 (step S62). At the same time, the output means 90 confirms whether there are any pre-processed orders which have not been transmitted to the printers 100 recorded in the pre-processed order recording means 75. If there are no pre-processed orders which have not been transmitted to the printers 100 recorded in the pre-processed order recording means 75, the output means 90 updates the printer status data for the printer 100 to “standby”, and the process ends (step S64: NO, step S68).

On the other hand, in the case that pre-processed orders which have not been transmitted to the printers 100 are recorded in the pre-processed order recording means 75 (step S64: YES), the output means 90 refers to the printing schedules 87. Then, the output means 90 outputs the order having the most imminent printing initiation time (designated as “order E”), from among the pre-processed orders recorded in the pre-processed order recording means 75, to the printer 100, which has transmitted the printing completion notification (step S70). At the same time, the output means 90 updates the printing schedules 87 and the printer status data 89, and stands by until the next notification of printing completion is received (step S72). Here, when updating the printing schedules 87, the output means updates both the printing initiation time and the printing completion time of the order E, which has been transmitted to one of the printers 100. Specifically, the printing initiation time of the order E is updated to the time that the order E was actually transmitted to the printer 100. Then, the printing completion time is estimated, based on the contents of the order E (such as number of images, number of prints, and print sizes) and the referenced data 88. The printing completion time of the printing schedule 87 for the order E is updated to this estimated printing completion time. Note that regarding the update of the printer status, the output means 90 updates the printer status of the printer 100 of the printer status data 89 within the database 84 to “printing order E”.

Note that the output means 90 also deletes the order number and the desired completion time of orders, for which printing completion notifications are received from the printer 100, from the desired completion time data 85 within the database 84.

Next, the scheduling means 95 of the control section 80 will be described. The scheduling means 95 performs the aforementioned Function 1, Function 2, Function 3, and Function 4. First, the processes by which Function 1 is performed, that is, calculation of reference completion times, will be described.

The scheduling means 95 calculates a reference completion time (in the present embodiment, the time at which printing is completed), by which a new order having standard contents (hereinafter, referred to as a “reference order”) to be received at the present time can be completed, based on the printing related processing schedules 86, the printing schedules 87, and the reference data 88.

First, a description will be given regarding a possible completion time in the case that the reference order is a “standard order” (in this case, the possible completion time is referred to as a “standard order reference completion time”). The photographic print system of the present embodiment generally performs processes on orders in the sequence that they are received. To calculate the possible completion time for a “standard” reference order, the scheduling means 95 first calculates the amount of time required for the printing related processes (hereinafter, referred to as “required printing related processing time”) by the printing related process executing means 70 and the amount of time required for the printing operation (hereinafter, referred to as “required printing time”) by the printers 100. The calculation is performed, based on the contents of the reference order (standard contents) and the reference data 88 of the database 84. Note that these two amounts of time may be calculated in advance and recorded as a part of the reference data 88 within the database 84.

The scheduling means 95 then refers to the printing related processing schedules 86, and obtains the latest printing related processing completion time, from among the printing related processing schedules 86, as a possible printing related process initiation time for the reference order. A possible printing related processing completion time for the reference order is calculated, based on the possible printing related process initiation time and the required printing related processing time. The scheduling means 95 further refers to the printing schedules 87 and the printer status data 89, to obtain the later of the possible printing related processing completion time calculated above and the printing completion time of the order in the printing schedules 87 having the latest printing initiation time, as a possible printing initiation time for the reference order. Next, the scheduling means 95 estimates the number of pre-processed orders which are not sent to the printers 100 and the status of each of the printers 100 at this possible printing initiation time. Finally, the scheduling means 95 calculates the time at which printing of the reference order will be completed, based on the results of the above estimate and the required printing time for the reference order, as the standard order reference completion time.

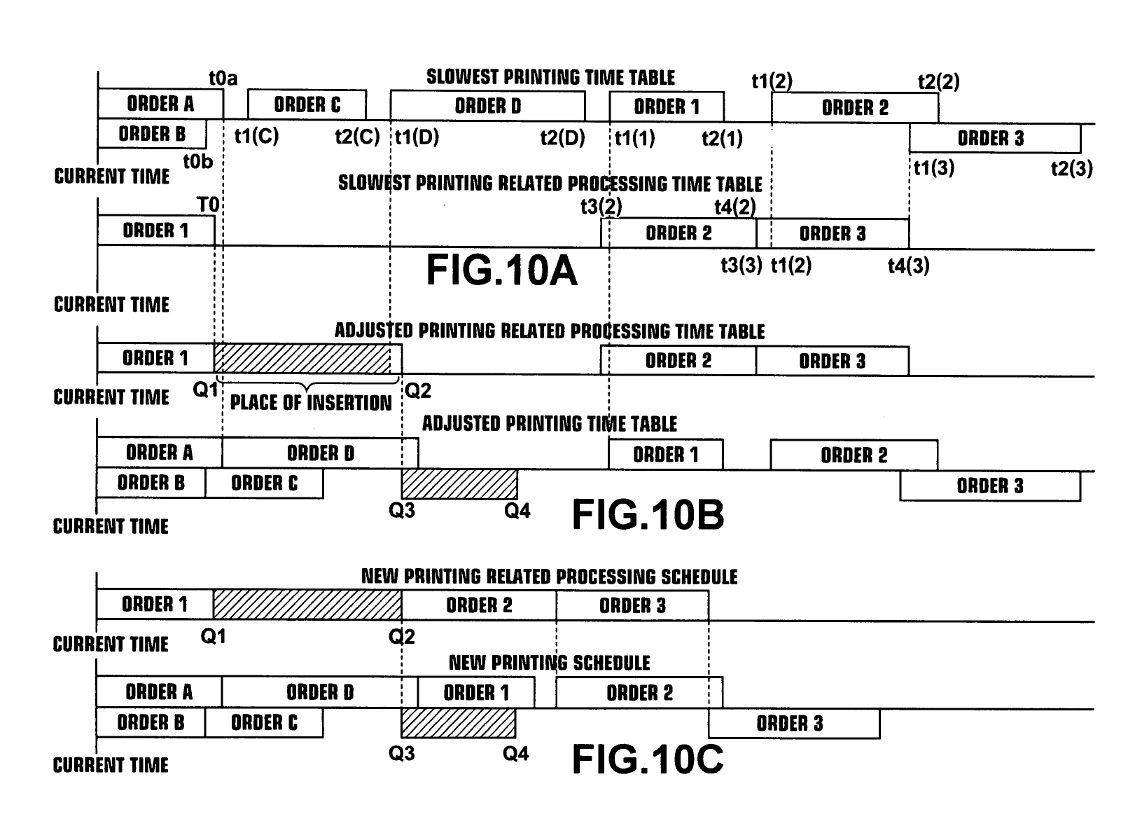

Next, a description will be given regarding a possible completion time in the case that the reference order is a “priority order” (in this case, the possible completion time is referred to as a “priority order reference completion time”). The photographic print system of the present embodiment generally performs processes on orders in the sequence that they are received. However, priority orders are processed as soon as possible, with the assumption that other existing orders are output before their desired completion times. Specifically, the scheduling means 95 first refers to the database 84, and generates a printing schedule such that all orders except those which have already been transmitted to the printers 100 (that is, orders which are being printed by the printers 100) will be printed before their desired completion times, as a “slowest printing time table”. The uppermost portion of FIG. 10A illustrates an example of the slowest printing time table. As illustrated in FIG. 10A, the slowest printing time table comprises a “latest printing completion time” t2, which is the desired completion time, and a “latest printing initiation time” t1 that enables completion of printing by the latest printing completion time, for each order. Note that the length of each order within the slowest printing time table represents the required printing time for each order, which is calculated based on the contents thereof. In addition, because the photographic print system of the present embodiment comprises two printers 100, two orders may be printed simultaneously, as exemplified by Order 2 and Order 3 in FIG. 10A.

The scheduling means 95 also refers to the printer status data 89 within the database 84, and inputs the printing completion times t0 of the orders being printed by the two printers 100 (Order A and Order B in FIG. 10A) into the slowest printing time table. In the example of FIG. 10A, Order A is being printed by printer A, and Order B is being printed by printer B. The printing completion times of Order A and Order B are denoted as t0a and t0b, respectively.

Then, the scheduling means 95 generates a “slowest printing related processing time table”, as illustrated in the lower portion of FIG. 10A. The slowest printing related processing time table comprises a “latest printing related process initiation time” t3 and a “latest printing related processing completion time” t4 for each order, on which the printing related processes have yet to be administered (each of the orders awaiting processing, recorded in the memory 62 of the printing related processing section 60). Here, the “latest printing related processing completion time” t4 for an order is the latest possible time prior to the “latest printing initiation time” t1 for the order. The “latest printing related process initiation time” t3 is a time that enables completion of the printing related processes by the “latest printing related processing completion time” t4. Note that the length of each order within the slowest printing related processing time table at the lower portion of FIG. 10A represents the required printing related processing time, which is calculated based on the contents thereof. The scheduling means 95 refers to the printing related processing schedules 86, and inputs the printing related processing completion time T0, of an order which is being processed by the printing related process executing means 70 (Order 1 in the example of FIG. 10A), into the slowest printing related processing time table.

In the example illustrated in FIG. 10A, Order 2 and Order 3 are awaiting printing related processing at the present time, and Order 1 is being processed by the printing related process executing means 70. Order C and Order D are pre-processed orders that are awaiting printing, and Order A and Order B are currently being printed.

The scheduling means 95 searches for a place (point in time) to insert the reference order as a priority order into the two time tables of FIG. 10A, while adjusting the places allotted to each existing order. First, the places allotted to the existing orders in the slowest printing related processing time table are adjusted, and the place at where the reference order is to be inserted is searched for. The scheduling means 95 performs the adjustment and search according to the following rules.

Rule 1: The start of the place of insertion (that is, the printing related process initiation time of the reference order) is at or after the printing related processing completion time (T0 in FIG. 10A) of an order which is currently being processed by the printing related process executing means 70 (Order 1 in FIG. 10A).

Rule 2: When adjusting the printing related processing times of orders that are awaiting the printing related processes (Order 2 and Order 3 in FIG. 10A), the ends of the printing related processing times (that is, the printing related processing completion times) of the adjusted orders do not become later than the latest printing related processing completion times (t4 (2) for Order 2, and t4 (3) for Order 3).

Rule 3: The place of insertion is determined to be the soonest place at where insertion is possible while adhering to the two rules above.

The scheduling means 95 judges whether it is possible to insert the printing related processes for the reference order between the printing related processing completion time T0 of the order currently being processed and the printing related process initiation time t3 of the order (Order 2 in FIG. 10A) that has the soonest printing related process initiation time (t3(2) in FIG. 10A) within the slowest printing related processing time table. Here, the judgment is performed, based on whether the amount of time between the points in time T0 and t3(2) is greater than or equal to the amount of time required for printing related processes to be administered on the reference order. In the case that it is judged that insertion is possible, the scheduling means 95 inserts the printing related processes for the reference order after the printing related processing completion time T0 of the order being currently processed. On the other hand, in the case that it is judged that insertion is not possible, the scheduling means 95 hastens the related processes for Order 2 to begin immediately after time T0, and judges whether it is possible to insert the printing related processes for the reference order between the printing related processing completion time t4(2) of Order 2 and the printing related process initiation time t3 of the next order (Order 3). In the same manner as above, in the case that it is judged that insertion is possible, the scheduling means 95 inserts the printing related processes for the reference order after the printing related processing completion time t4(2) of Order 2. On the other hand, in the case that it is judged that insertion is not possible, the scheduling means 95 hastens the related processes for Order 3 to begin immediately after the printing related processing completion time t4 (2) of Order 2. The scheduling means 95 repeats the above processes until a place where the printing related processes for the reference order to be inserted is found. The upper portion of FIG. 10B illustrates an example of a place where the printing related processes for the reference order can be inserted, detected by the scheduling means 95. The shaded portion (printing related process initiation time Q1-printing related processing completion time Q2) in FIG. 10B indicates the place at which the reference order is inserted into the printing related processing time table. The length of the shaded portion (Q1-Q2) is the required printing related processing time of the reference order.

Next, the scheduling means 95 adjusts the places allotted to the existing orders in the slowest printing time table are adjusted, and the place at where the reference order is to be inserted is searched for. The scheduling means 95 performs the adjustment and search according to the following rules.

Rule 1: Orders which are currently being printed (Order A and Order B in FIG. 10A) are not to be adjusted.

Rule 2: The printing initiation time of the reference order is to be the same as or after the printing related processing completion time Q2 thereof.

Rule 3: When adjusting the printing times of orders that are awaiting printing (Order C, Order D, Order 1, Order 2, and Order 3 in FIG. 10A), the ends of the printing times (that is, the printing completion times) of the adjusted orders do not become later than the latest printing completion times t2 thereof (t2(C), t2(D), t2(1), t2(2), and t2(3) for the orders in FIG. 10A, respectively).

Rule 4: The place of insertion is determined to be the soonest place at where insertion is possible while adhering to the three rules above.

First, the scheduling means 95 hastens the printing times of all of the orders in the slowest printing time table having latest printing initiation times t1 prior to the printing related processing completion time Q2 of the reference order (Order C and Order D in FIG. 10A). Here, there are two printers 100. Therefore, printing of the orders is hastened such that each printer 100 begins printing of a next order as soon as printing of the current order being printed is completed.

By referring to the slowest printing time table at the upper portion of FIG. 10A and the adjusted printing related processing time table at the upper portion of FIG. 10B, it can be seen that the latest printing initiation times t1 of Order C and order D are before the printing related processing completion time Q2 of the reference order. Therefore, the scheduling means 95 hastens the printing times of Order C and Order D, as illustrated in the upper portion of FIG. 10B. Next, the scheduling means 95 judges whether printing of the reference order can be inserted between the printing related processing completion time Q2 of the reference order and the latest printing initiation time t1 of the next order (Order 1 in FIG. 10A and FIG. 10B). In the case that it is judged that insertion is possible, the insertion is performed. In the case that it is judged that insertion is not possible, printing of Order 1 is hastened, and a place where printing of the reference order can be inserted after the printing completion time of Order 1 is searched for.

The lower portion of FIG. 10B illustrates an example of a place where the reference order has been inserted into the printing time table, obtained by the aforementioned adjustments and search by the scheduling means 95. The shaded portion represents the place where printing of the reference order can be inserted. Time Q3 is the printing initiation time (the printing initiation time Q3 is the soonest possible time following the printing related processing completion time Q2, and is the same as the printing related processing completion time Q2 in FIG. 10B), and time Q4 is the printing completion time of the reference order. Note that the length of the shaded portion (Q3-Q4) is the required printing time for the reference order. Here, when inserting printing of the reference order, the printer 100, which is not currently printing another order, is selected as the printer 100 for printing the reference order. In the example of FIG. 10B, printer A is printing order D at time Q2, and therefore, printer B is selected as the printer 100 for printing the reference order. In the case that neither of the two printers 100 is printing orders at time Q2, either printer 100 may be selected to print the reference order. However, it is preferable for the printer 100 printing the order having the sooner printing completion time to be selected to print the reference order.

The scheduling means 95 detects places for inserting the printing related processes and printing of the reference order in this manner. The printing completion time, at the end of the place at where printing is inserted (time Q4 in FIG. 10B), is obtained as the priority order reference completion time.

The scheduling means 95 calculates the standard order reference completion time and the priority order reference completion time in the manner described above, then provides the reference completion times to the order receiving apparatus 10.

The scheduling means 95 performs the following processes, in order to serve the aforementioned Functions 2, 3, and 4 (that is, to judge whether output of a new order is possible by the desired completion time; calculating a possible completion time in the case that output by the desired completion time is not possible, separately for standard and priority orders; and generating a printing related processing schedule and a printing schedules in the case that output by the desired completion time is possible).

The order receiving apparatus 10 of the photographic printing system of the present embodiment enables users to select the type of order to be placed (standard or priority), and also to input a desired completion time. The order receiving apparatus 10 transmits the contents of a received new order to the server 50, and the type of order and the desired completion time are included in the transmitted contents. Further details of the order receiving apparatus 10 will be described later. The communication section 52 of the server 50 receives the contents of the new order, and the memory 82 of the control section 80 temporarily stores the contents therein. Next, the scheduling means 95 of the control section 80 calculates a possible completion time for the new order, based on the contents thereof stored in the memory 82. Here, the scheduling means 95 calculates a possible completion time for a case in which the new order is processed as a standard order, in the case that the new order is specified as a standard order. On the other hand, the scheduling means 95 calculates a possible completion time for a case in which the new order is processed as a priority order, in the case that the new order is specified as a priority order. The method for calculating the possible completion time is the same as that for calculating the reference completion time described above, except that the required printing related processing time and the required printing time are obtained based on the contents of the new order, instead of using the standard contents for the reference order. Therefore, a detailed description of the calculation method will be omitted.

The scheduling means 95 compares the possible completion time for the new order calculated in this manner against the desired completion time, and judges whether output by the desired completion time is possible, based on whether the desired completion time is after the possible completion time. Here, the processes performed by the scheduling means 95 for cases in which output by the desired completion time is “possible” and “not possible” will be described.

In the case that it is judged that output of a new standard order is not possible by the desired completion time, the scheduling means 95 performs the following processes. First, a possible completion time for a case in which the new order is processed as a priority order (hereinafter, referred to as “priority order possible completion time”) is calculated. Then, the possible completion time for the new standard order (hereinafter, referred to as “standard order possible completion time”), which has been calculated for use in the judgment regarding whether output by the desired completion time is possible, the priority order possible completion time, and the judgment results are transmitted to the order receiving apparatus 10.

In the case that it is judged that output of a new priority order is not possible by the desired completion time, the scheduling means 95 performs the following processes. First, a possible completion time for a case in which the new order is processed as a standard order, that is, a priority order possible completion time, is calculated. Then, the priority order possible completion time, which has been calculated for use in the judgment regarding whether output by the desired completion time is possible, the standard order possible completion time, and the judgment results are transmitted to the order receiving apparatus 10.

In the case that it is judged that output of a new standard order is possible by the desired completion time, the scheduling means 95 performs the following processes. First, the judgment results are transmitted to the order receiving apparatus. If data indicating a user's desire to place the order is transmitted from the order receiving apparatus 10 in response to the transmission of the judgment results, the scheduling means 95 adds the possible printing related processing initiation time, the possible printing related processing completion time, the possible printing initiation time, and the possible printing completion time, which had been calculated for the aforementioned judgment, into the printing related processing schedules 86 and the printing schedules 87 of the database 84, as the printing related processing schedule and the printing schedule of the new order. The scheduling means 95 also adds the order number and the desired completion time of the new order to the desired completion time data 85.

In the case that it is judged that output of a new priority order is possible by the desired completion time, the scheduling means 95 transmits the judgment results to the order receiving apparatus. If data indicating a user's desire to place the order is transmitted from the order receiving apparatus 10 in response to the transmission of the judgment results, the scheduling means 95 performs the following processes. First, the processing times of each of the orders, illustrated in the adjusted printing related processing time table at the upper portion of FIG. 10B, are grouped such that there are no gaps therebetween. Thereby, a time table as illustrated in the upper portion of FIG. 10C is obtained, as new printing related processing schedules for the orders. Next, the processing times of the orders which are to be printed after the priority order, that is, Order 1, Order 2, and Order 3 in the adjusted printing time table at the lower portion of FIG. 10B, are hastened. Thereby, a time table as illustrated in the lower portion of FIG. 10C is obtained, as new printing schedules for the orders. Note that when hastening the processing times of the orders to be printed after the priority order, the printing initiation times are not to be set prior to the new printing related processing completion times therefor, which are illustrated in the upper portion of FIG. 10C.

The scheduling means 95 updates the printing related processing schedules 86 and the printing schedules 87 in the database 84 to the new printing related processing schedules and the new printing schedules illustrated in FIG. 10C. The scheduling means 95 also adds the order number and the desired completion time of the new order to the desired completion time data 85.

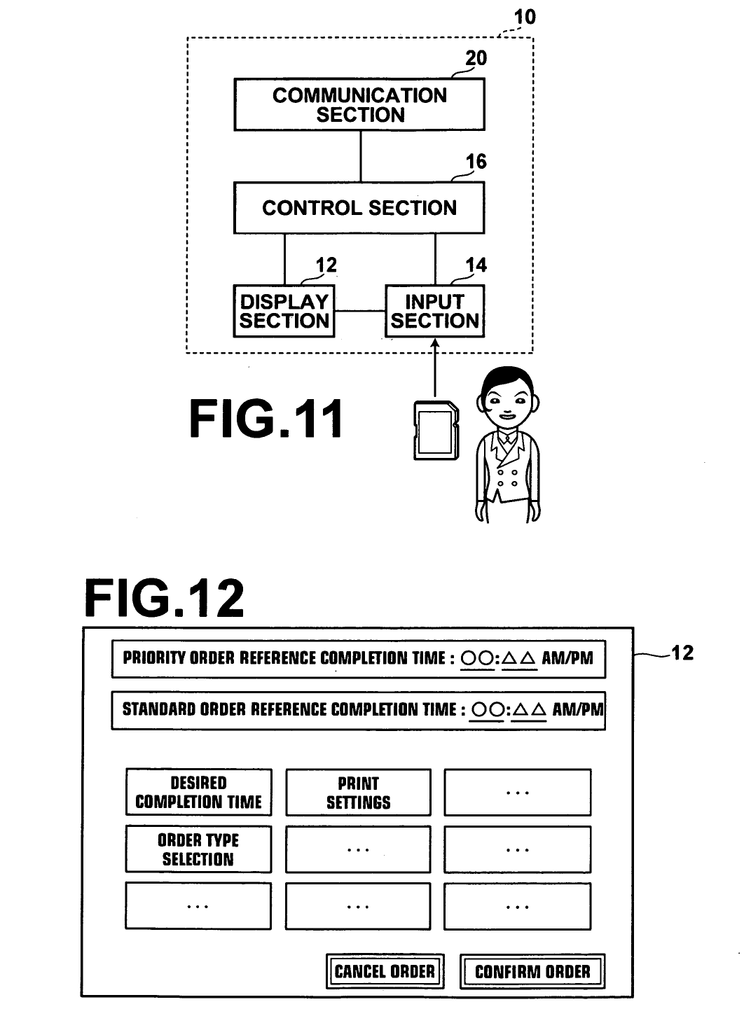

Finally, the order receiving apparatus 10 will be described. FIG. 11 is a block diagram that illustrates the construction of the order receiving apparatus 10 of the photographic printing system of FIG. 1. As illustrated in FIG. 11, the order receiving apparatus 10 of the present embodiment comprises: a display section 12; an input section 14, for causing users to perform various types of input to order photographic prints; a communication section 20 for communicating with the server 50 and the user terminals PC1; and a control section 16, for controlling the operations of each of the aforementioned components. Note that the input section 14 of the order receiving apparatus 10 is capable of directly receiving user input, as well as receiving user input from the user terminals PC1, which are connected thereto via the Internet. Note that although not illustrated in FIG. 11, the input section 14 comprises an interface, into which media having images recorded therein, such as memory cards, can be inserted.

The display section 12 displays various types of information for the users to order photographic prints, and may be an LCD panel, a CRT monitor, or the like. Note that in the case that the users place orders by employing the user terminals PC1, the display section 12 causes the monitors of the user terminals PC1 to display the information via the Internet.

FIG. 12 is an example of a display screen of the display section 12. In the case that users are placing orders employing the user terminals PC1, the display section 12 causes the monitor of the user terminals PC1 to display the display screen.

Users are enabled to set various settings, which are displayed by the display section 12, by operating the input section14. Users can confirm placement of orders by pressing the “Confirm Order” button displayed on the screen by the display section 12, and can cancel orders, by pressing the “Cancel Order” button. Here, regarding the item “Desired Completion Time”, users are enabled to input desired completion times. Regarding the item “Order Type”, users are enabled to select between “Priority Order” and “Standard Order”.

The control section 16 constantly obtains the priority order reference completion time and the standard order reference completion time at the present time, from the scheduling means 95 of the control section 80 of the server 50, via the communication section 20. The two reference completion times are constantly displayed by the display section 12, as illustrated in FIG. 12, prior to user input of the contents of a new order (input via the input section 14, including access from the user terminals PC1), or in case some operations for order placement are being performed, but the contents of a new order have not yet been input. At this time, it is preferable that the contents of the standard order, on which the reference completion times are calculated, are displayed as well, to aid the user's judgment of the system's processing status.

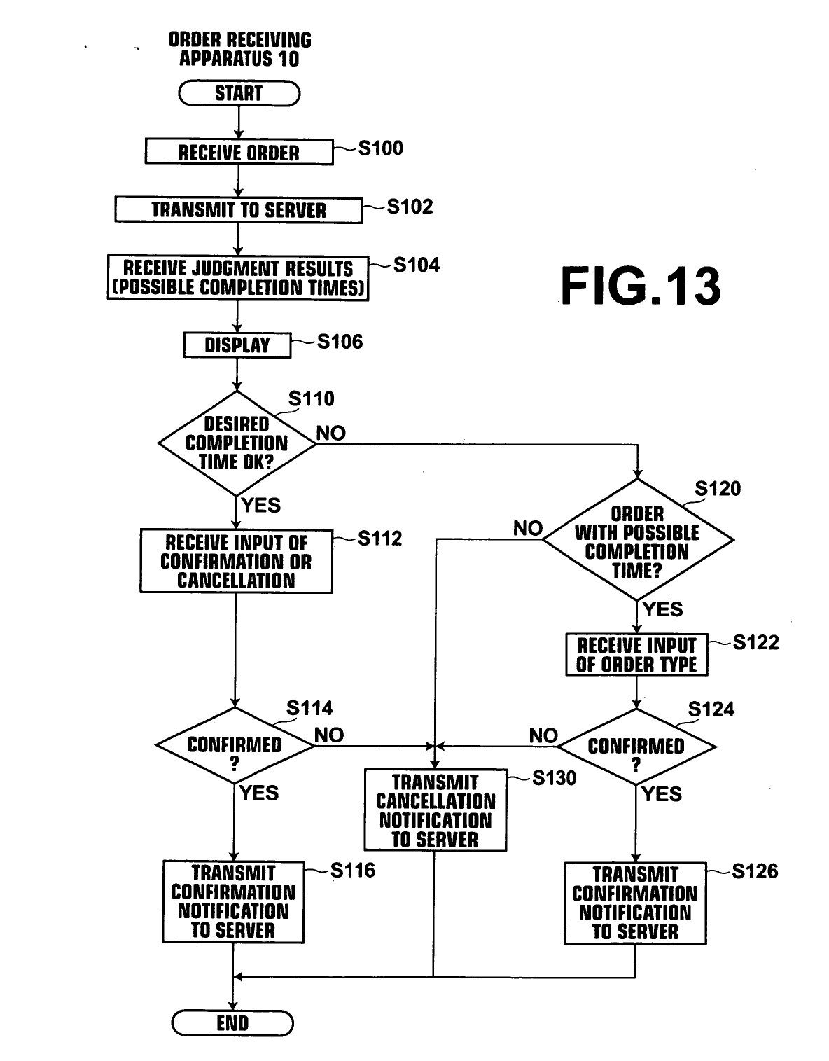

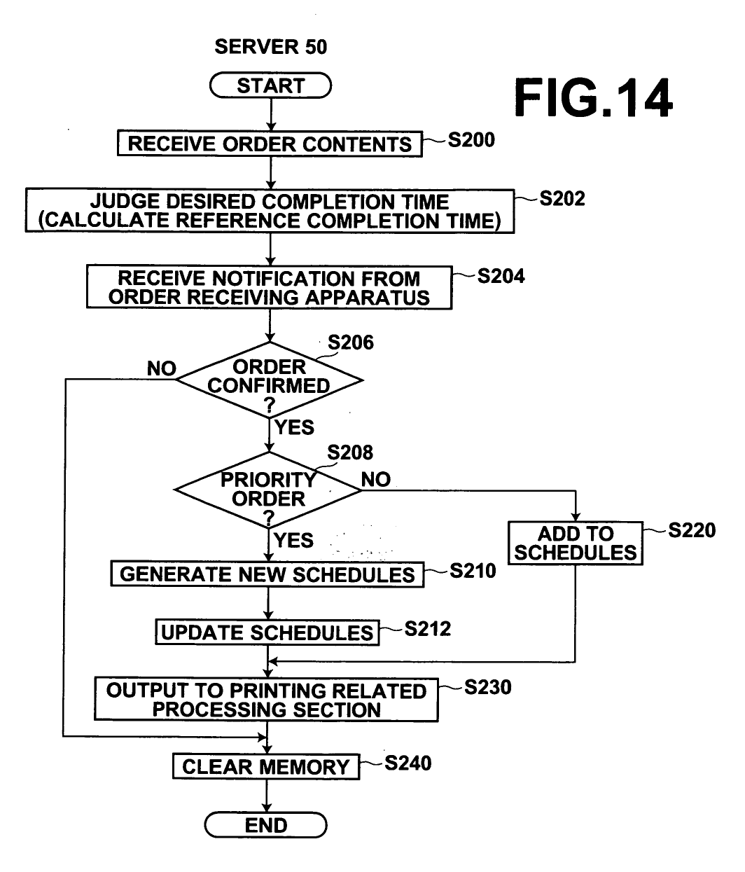

When the contents of a new order are input to the order receiving apparatus 10 by a user, the control section 16 transmits the contents of the new order to the server 50. The server performs processes, such as judgment regarding whether output of the new order by the desired completion time is possible, and transmits the judgment results to the order receiving apparatus 10. The control section 16 performs the processes that follow, based on the judgment results transmitted from the server 50. Here, the operation of the order receiving apparatus 10 and the server 50, after the contents of an order are input to the order receiving apparatus 10 by a user, will be described, with reference to FIG. 13 and FIG. 14. FIG. 13 is a flow chart that illustrates the operation of the control section 16, after the contents of a new order are input to the order receiving apparatus 10 by a user. FIG. 14 is a flow chart that illustrates the operation of the server 50, after it receives the contents of a new order from the control section 16.

As illustrated in FIG. 13, when the contents of the new order are input to the order receiving apparatus 10 (the number of images is known, due to a memory card being inserted or due to transmission of the images via a network; and print sizes, a desired completion time, and the type of order has been input), the control section 16 transmits the contents of the new order to the server 50, to enable judgment thereby regarding whether output by the desired completion time is possible (steps S100, S102). When the contents of the new order are received, the server 50 judges whether output by the desired completion time is possible, and transmits the judgment results to the order receiving apparatus 10. When the server 50, more specifically, the scheduling means 95 of the control section 80 thereof, judges that output by the desired completion time is not possible, possible completion times for the new order (a priority order possible completion time, in the case that the new order is processed as a priority order; and a standard order possible completion time, in the case that the new order is processed as a standard order) are calculated, based on the contents of the new order, and transmitted to the order receiving apparatus 10, along with the judgment results indicating “Output Not Possible”. When the judgment results transmitted from the server 50 are received, the control section 16 of the order receiving apparatus 10 causes the display section 12 to display the judgment results. Note that in the case that the judgment results are “Output Not Possible”, the two possible completion times transmitted therewith are also displayed (steps S104, S106). The control section 16 prompts the user to input either a command to confirm placement of the order, or a command to cancel the order (step S110: YES, step S112). If an order confirmation command is input by the user pressing the “Confirm Order” button (step S114: YES), the images included in the new order (the images to be output as photographic prints) are transmitted to the server 50. Notification that the order placement has been confirmed, to be processed according to the desired completion time is transmitted to the server 50 (step S116) along with the images, and the order receiving procedure ends. On the other hand, if an order cancellation command is input by the user pressing the “Cancel Order” button (step S114: NO), the control section 16 notifies the server 50 that the order has been canceled, and the order receiving procedure ends.

Regarding new orders for which output by the desired completion time has been judged to be not possible, the control section 16 prompts the user to input a command to confirm placement of the order with one of the possible completion times transmitted from the server 50, or to input a command to cancel the order (step S120). If an order cancellation command is input by the user pressing the “Cancel Order” button (step S120: NO), the control section 16 notifies the server 50 that the order has been canceled (step S130), and the order receiving procedure ends. On the other hand, if an order confirmation command is input by the user pressing the “Confirm Order” button and selecting either the priority or the standard order type (step S120: YES, step S122), notification that the order placement has been confirmed, to be processed according to the desired completion time is transmitted to the server 50 (step S126) along with the images and the selected order type (Standard or Priority), and the order receiving procedure ends.

FIG. 14 is a flow chart that illustrates the operations of the server 50 after receiving the contents of the new order from the order receiving apparatus 10. As illustrated in FIG. 14, the server 50 receives the contents of the new order from the order receiving apparatus 10, via the communication section 52 (step S200). Note that this step corresponds to step S102, at which the order receiving apparatus 10 transmits the contents of the new order, in the flow chart of FIG. 13. The scheduling means 95 temporarily stores the contents of the new order in the memory 82, and judges whether output is possible by the desired completion time (step S202). As described previously, the scheduling means 95 performs judgment after adjusting the schedules (printing related processing schedules and printing schedules) of existing orders in the case that the new order is a priority order, whereas judgment is performed without adjusting the schedules of the existing orders in the case that the new order is a standard order. Note that the scheduling means 95 obtains the possible printing related processing initiation time, the possible printing related processing completion time, the possible printing initiation time, and the possible printing completion time for new standard orders, when performing judgments regarding whether output by the desired completion time is possible. These times are stored in the memory 82 for the new standard orders. Meanwhile, the two adjusted time tables illustrated in FIG. 10B are obtained during judgment regarding whether output by the desired completion time for new priority orders. The two adjusted time tables are stored in the memory 82 for the new priority orders.

The scheduling means 95 of the control section 80 of the server 50 transmits judgment results indicating “Output Possible” for new orders, for which output by the desired completion time are judged to be possible. If the scheduling means 95 judges that output by the desired completion time is not possible, a priority order possible completion time, in the case that the new order is processed as a priority order; and a standard order possible completion time, in the case that the new order is processed as a standard order are calculated, and the two possible completion times are transmitted to the order receiving apparatus 10, along with the judgment results indicating “Output Not Possible”. Note that the scheduling means 95 obtains the possible printing related processing initiation time, the possible printing related processing completion time, the possible printing initiation time, and the possible printing completion time in the case that priority orders, for which “Output Not Possible” judgments have been rendered, are processed as standard orders. These times are stored in the memory 82 for the priority orders. Meanwhile, the two adjusted time tables illustrated in FIG. 10B are obtained in the case that standard orders, for which “Output Not Possible” judgments have been rendered, are processed as priority orders. The two adjusted time tables are stored in the memory 82 for the new priority orders.

The scheduling means 95 transmits the judgment results obtained in step S202; and the possible priority order completion time and the possible standard order completion time, which have been calculated for new orders which have been judged as “Output Not Possible”, to the order receiving apparatus 10. The scheduling means 95 performs the processes to follow, according to notification received (step S204) in response to the transmission. There are three types of notification that may be received at step S204. They are: notification that an order cancellation command has been input (corresponding to step S130 in the flow chart of FIG. 13); notification that order placement has been confirmed, to be processed according to the desired completion time (corresponding to step S116 in the flow chart of FIG. 13); and order placement has been confirmed, to be processed according to the possible completion time for the selected order type. If the notification of order cancellation is received, the scheduling means 95 deletes the contents related to the new order (such as the contents of the order and possible completion times), which are stored in the memory 82 (step S206: NO, step S240), and the procedure ends. On the other hand, if either type of notification of order placement is received, the scheduling means 95 further confirms whether the new order is to be processed as a standard order or as a priority order (step S206: YES, step S208).

Here, there are two types of orders which are “to be processed as a standard order”. The two types are: a standard order for which an “Output Possible” judgment has been rendered; and an order (a priority order or a standard order) for which an “Output Not Possible” judgment has been rendered, but for which notification that order placement has been confirmed, to be processed according to the possible standard order completion time, has been received. There are also two types of orders which are “to be processed as a priority order”. The two types are: a priority order for which an “Output Possible” judgment has been rendered; and an order (a priority order or a standard order) for which an “Output Not Possible” judgment has been rendered, but for which notification that order placement has been confirmed, to be processed according to the possible priority order completion time, has been received. For an order to be processed as a standard order (step S208: NO), the scheduling means 95 adds the printing related processing initiation time, the printing related processing completion time, the printing initiation time, and the printing completion time, obtained in step S202 and stored in the memory 82, to the printing related processing schedules 86 and the printing schedules 87 in the database 84, as the printing related processing schedule and the printing schedule for the order (step S220). At the same time, the order number and the desired completion time (the desired completion time for a standard order, for which an “Output Possible” judgment has been rendered, and the possible standard order completion time for a standard order or a priority order, for which an “Output Not Possible” judgment has been rendered, but for which notification that order placement has been confirmed, to be processed according to the possible standard order completion time, has been received) of the order are added to the desired completion time data 85. For an order to be processed as a priority order (step S208: YES), the scheduling means 95 employs the two adjusted time tables illustrated in FIG. 10B, obtained in step S202 and stored in the memory 82, to generate the new printing related processing schedule and the new printing schedule illustrated in FIG. 10C (step S210), and updates the printing related processing schedules 86 and the printing schedules 87 in the database 84 with the two new schedules (step S212). At the same time, the order number and the desired completion time (the desired completion time for a priority order, for which an “Output Possible” judgment has been rendered, and the possible priority order completion time for a standard order or a priority order, for which an “Output Not Possible” judgment has been rendered, but for which notification that order placement has been confirmed, to be processed according to the possible priority order completion time, has been received) of the order are added to the desired completion time data 85.

The output means 90 of the control section 80 of the server 50 outputs orders, for which order confirmation notifications have been received, to the printing related processing section 60 along with the added or updated printing related processing schedules 86 (step S230). Then the contents of the memory 82 are deleted (step S240), and the procedure ends.

In this manner, the order receiving apparatus 10 of the photographic printing system according to the present embodiment receives desired completion times for new orders, along with the new orders. The server 50 judges whether output of the new orders is possible by the desired completion times, based on the contents of the new orders and the processing state of existing orders. The order receiving apparatus 10 notifies the judgment results obtained by the server 50. Thereby, the user can be informed whether it is possible for an order to be output by a desired completion time. Accordingly, the user can decide whether to place the order, to change the desired completion time and then place the order, or to cancel the order.

The server 50 generates schedules for received orders, and controls the processing components thereof such that the output processes are performed according to the schedules. Thereby, judgment regarding whether completion of new orders by their desired completion times is possible is enabled.

In conventional photographic printing systems, it had not been possible to ascertain the backlog of orders and the processing states of various components of the systems. Therefore, it had been necessary to set completion times such that some leeway was added to the actual time required for processing, in order to ensure output by the set completion times. The control section 80 of the photographic printing system according to the present embodiment schedules the processes for each order, and accurately keeps track of the backlog of orders and the processing states of the various components. Therefore, the need to add leeway to the completion times is obviated, and the fastest possible completion times become possible.

In the photographic image outputting system according to the present embodiment, orders are classified into standard orders and priority orders. The scheduling means 95 performs the judgment and generates the schedule for priority orders, after adjusting the schedules of existing orders within an adjustable range that still enables output of the existing orders by their desired completion times. Therefore, the maximum number of new orders can be received, while all orders are output by their desired completion times, which is efficient.

In the photographic image outputting system of the present embodiment, a possible completion time when a new order can be completed is calculated and displayed, in the case that the scheduling means judges that completion by the desired completion time is not possible. In this case, it is easy for a user to decide whether to change the desired completion time and place the new order or to cancel the new order.

Further, the photographic image outputting system of the present embodiment calculates and displays a reference completion time for a new order having standard contents at the time the new order is to be placed. Therefore, a user can know the approximate possible completion time for their order prior to placing their order, which is convenient.

In the photographic image outputting system of the present embodiment, processing schedules for orders are generated such that pre-processed orders are not transmitted to the printers 100, in the case that the printers 100 are currently printing another order, while adhering to schedules that enable output of all orders by their desired completion times. By generating the schedules in this manner, the schedules of orders, other than the orders which are currently being printed, can be adjusted more efficiently, in the case that a new priority order is received.

A preferred embodiment of the photographic image outputting system of the present invention has been described above. However, the photographic image outputting system of the present invention is not limited to the above embodiment. Various changes and modifications are possible, as long as they do not stray from the spirit of the invention.

For example, the photographic image printing system of the embodiment illustrated in FIG. 1 prints images which are recorded in memory cards or transmitted via a network. Alternatively, an apparatus for reading images from photographic films, such as a scanner, may be provided, and images recorded on photographic films may also be printed.

In the photographic image printing system of the embodiment illustrated in FIG. 1, the server constantly calculates the reference completion time, and the order receiving apparatus 10 constantly displays the reference completion time. Alternatively, the reference completion time may be calculated and displayed at predetermined intervals, such as every five or every ten minutes. As a further alternative, the reference completion time may be calculated and displayed in the case that a user expresses a desire to place an order, by physically approaching the order receiving apparatus 10, or by accessing the order receiving apparatus 10 via a network. As still a further alternative, the reference completion time may be calculated constantly, but only displayed when the user expresses a desire to place an order.

Further, a “Display Reference Completion Time” button may be provided on the order receiving apparatus 10, and the reference completion time may be displayed when the user presses the button.

In the photographic printing system of the present embodiment, all orders awaiting printing are stored in the server 50, in the case that the printers 100 are currently printing other orders. Alternatively, a single pre-processed order may be transmitted to each printer 100 while it is printing another order, and stored in a queue thereof. Thereby, the transmission time for the order can be shortened, when the printer 100 completes printing of the other order.

In the photographic printing system of the present embodiment, there are two degrees of priority for orders, “Standard” and “Priority”. Priority orders are processed faster, whereas standard orders are processed in the order that they are received. Alternatively, there may be three or more different degrees of priority for orders. In this case, the degree of prioritization of processing for orders of each degree of priority may be different. For example, in the case that there are three different degrees of priority, “Standard” orders, having the lowest priority, may be processed in the order that they are received. “Priority 1” orders, having the highest priority, may be processed such that they are output at the soonest possible time, while ensuring that existing orders are output by their desired completion times. “Priority 2” orders, having the second highest priority, may be processed such that they are output by their desired completion times, while ensuring that existing orders are output by their desired completion times.

In the description of the photographic printing system of the present embodiment, the printing completion time is referred to as the completion time of an order, for the sake of simplicity. However, the time required to seal photographic prints, output by the system, into bags for delivery may be added after the printing completion time, and the later time may be the completion time of an order.

Business hours may be factored into the calculations of the schedules. In this case, the administrator of the system may decide whether to perform processing outside of business hours. They may decide to not perform any processing outside of business hours, or to perform processing only for priority orders outside of business hours.

In addition, the time required to replace photographic printing paper in the printers may be estimated, and factored into the calculations of the schedules.

The photographic printing system of the present embodiment generates schedules such that orders are output at the soonest possible time prior to their desired completion times, and processing by the components is controlled according to the schedules. Alternatively, the time tables illustrated in FIG. 10A may be displayed to an operator, and the operator may be prompted to perform the processes that cause each order to be output by the latest printing completion times, in the case that the processes fall behind schedule.

A configuration may be adopted, wherein verification processes for priority orders are not prioritized in the printing related processing section 60, but rather omitted for priority orders. That is, a configuration may be adopted wherein only the automatic setup processes are administered on priority orders.

A configuration may be adopted, wherein different charges may be billed for priority orders and standard orders.

A configuration may be adopted, wherein degrees of priority are not set for orders. In this case, a place to insert a new order into the schedules such that the new order is output as soon as possible is searched for, while adjusting the schedules of existing orders within a range that ensures that the existing orders will be output by their desired completion times.

The embodiment illustrated in FIG. 1 comprises a single server 50 and a plurality of printers 100. However, the number of servers and the number of printers may vary.

Some components, which have little relevancy to the spirit of the present invention and which one skilled in the art would provide, have been omitted from the description and drawings of the photographic printing system of the embodiment illustrated in FIG. 1.

The system of the present embodiment is that which outputs photographic images as prints. However, the photographic image outputting system of the present invention is not limited to this configuration, and may be applied to a system that records photographic images onto recording media.

In the photographic printing system of the present embodiment, the user terminal PC1 and the order receiving apparatus 10 are connected by the Internet, as an example. Alternatively, the user terminal PC1 and the order receiving apparatus 10 may be connected by any network, such as a dedicated network. Further, the user terminals are not limited to being computers, and may be any terminal device capable of accessing the order receiving apparatus 10, such as a mobile telephone.

In the photographic printing system of the present embodiment, the order receiving apparatus 10, the server 50, and the printers 100 are provided as separate components connected by a network. Alternatively, any two or all three of the components may be integrated.

What is claimed is:

1. A photographic image outputting system, comprising:
an order receiving apparatus having receiving means, for receiving orders for photographic image output;
an output processing apparatus, for performing output processes regarding the orders received by the order receiving apparatus; and
a control apparatus, for controlling the output processing apparatus; wherein:
the receiving means also receives a desired completion time;
the control apparatus comprises:
scheduling means, for judging whether completion by the desired completion time for a new order is possible, based on the contents of the new order received by the receiving means and the processing state of existing orders received prior to the new order, and for generating an output processing schedule for the new order, in the case that it is judged that completion by the desired completion time is possible; and
schedule control means, for causing the output processing apparatus to perform outputting processes for the new order according to the schedule generated by the scheduling means; and
the order receiving apparatus further comprises:
notifying means, for displaying the results of the judgment performed by the scheduling means.

2. A photographic image outputting system as defined in claim 1, wherein:
the output processing apparatus printing photographic images included in the order and/or records the photographic images included in the order in recording media.

3. A photographic image outputting system as defined in claim 1, wherein:
the scheduling means performs the judgment and generates the schedule after adjusting the schedules of existing orders, for which the schedules are adjustable within an adjustable range; and
the schedule control means controls the output processing apparatus such that existing orders, of which the schedules have been adjusted, are output according to the adjusted schedule thereof.

4. A photographic image outputting system as defined in claim 2, wherein:
the scheduling means performs the judgment and generates the schedule after adjusting the schedules of existing orders, for which the schedules are adjustable within an adjustable range; and
the schedule control means controls the output processing apparatus such that existing orders, of which the schedules have been adjusted, are output according to the adjusted schedule thereof.

5. A photographic image outputting system as defined in claim 1, wherein:
the control apparatus further comprises possible completion time calculating means, for calculating a possible completion time when the new order can be completed, in the case that the scheduling means judges that completion by the desired completion time is not possible; and
the notifying means displays the possible completion time calculated by the possible completion time calculating means.

6. A photographic image outputting system as defined in claim 2, wherein:
the control apparatus further comprises possible completion time calculating means, for calculating a possible completion time when the new order can be completed, in the case that the scheduling means judges that completion by the desired completion time is not possible; and
the notifying means displays the possible completion time calculated by the possible completion time calculating means.

7. A photographic image outputting system as defined in claim 3, wherein:
the control apparatus further comprises possible completion time calculating means, for calculating a possible completion time when the new order can be completed, in the case that the scheduling means judges that completion by the desired completion time is not possible; and
the notifying means displays the possible completion time calculated by the possible completion time calculating means.

8. A photographic image outputting system as defined in claim 4, wherein:
the control apparatus further comprises possible completion time calculating means, for calculating a possible completion time when the new order can be completed, in the case that the scheduling means judges that completion by the desired completion time is not possible; and
the notifying means displays the possible completion time calculated by the possible completion time calculating means.

9. A photographic image outputting system as defined in claim 1, wherein:
the control apparatus further comprises reference completion time calculating means, for calculating a reference completion time when a new order having standard contents can be completed at the time that the new order is received, based on the schedules of existing orders; and
the notifying means displays the reference completion time calculated by the reference completion time calculating means.

10. A photographic image outputting system as defined in claim 2, wherein:
the control apparatus further comprises reference completion time calculating means, for calculating a reference completion time when a new order having standard contents can be completed at the time that the new order is received, based on the schedules of existing orders; and
the notifying means displays the reference completion time calculated by the reference completion time calculating means.

11. A photographic image outputting system as defined in claim 3, wherein:
the control apparatus further comprises reference completion time calculating means, for calculating a reference completion time when a new order having standard contents can be completed at the time that the new order is received, based on the schedules of existing orders; and
the notifying means displays the reference completion time calculated by the reference completion time calculating means.

12. A photographic image outputting system as defined in claim 4, wherein:
the control apparatus further comprises reference completion time calculating means, for calculating a reference completion time when a new order having standard contents can be completed at the time that the new order is received, based on the schedules of existing orders; and
the notifying means displays the reference completion time calculated by the reference completion time calculating means.

13. A photographic image outputting system as defined in claim 1, wherein:
the receiving means receives the orders for photographic image output with different degrees of output priorities;
the scheduling means generates the schedules such that output processes are performed first for orders having higher degrees of output priorities, and judges whether completion of a new order is possible, according to the degree of output priority of the new order and the degrees of output priorities of the existing orders.

14. A photographic image outputting system as defined in claim 2, wherein:
the receiving means receives the orders for photographic image output with different degrees of output priorities;
the scheduling means generates the schedules such that output processes are performed first for orders having higher degrees of output priorities, and judges whether completion of a new order is possible, according to the degree of output priority of the new order and the degrees of output priorities of the existing orders.

15. A photographic image outputting system as defined in claim 3, wherein:
the receiving means receives the orders for photographic image output with different degrees of output priorities;
the scheduling means generates the schedules such that output processes are performed first for orders having higher degrees of output priorities, and judges whether completion of a new order is possible, according to the degree of output priority of the new order and the degrees of output priorities of the existing orders.

16. A photographic image outputting system as defined in claim 4, wherein:
the receiving means receives the orders for photographic image output with different degrees of output priorities;
the scheduling means generates the schedules such that output processes are performed first for orders having higher degrees of output priorities, and judges whether completion of a new order is possible, according to the degree of output priority of the new order and the degrees of output priorities of the existing orders.

17. A photographic image outputting system as defined in claim 1, wherein:
the order receiving apparatus further comprises readout means for reading images out from photographic film; and
the order receiving apparatus obtains the images read out by the readout means as the photographic images of the orders for photographic image output.

18. A photographic image outputting system as defined in claim 10, wherein:
the notifying means displays the reference completion time, in response to an operation by a user of the order receiving apparatus that indicates desire to place an order.

19. A photographic image outputting system as defined in claim 18, wherein:
the order receiving apparatus comprises a reference completion time display button, for requesting display of the reference completion time; and
the notifying means displays the reference completion time in response to a user pressing the reference completion time display button.

20. A photographic image outputting system as defined in claim 1, wherein:
the notifying means displays a time table that represents the schedule.
